(19) United States
(12) Patent Application Publication
(10) Pub. No.: US 2002/0044901 A1
(43) Pub. Date: Apr. 18, 2002

(54) DESULFURIZATION OF GASES WITH CERIUM OXIDE MICRODOMAINS

(76) Inventors: WILLIAM G. WILSON, PITTSBURGH, PA (US); LAWRENCE L. MURRELL, SOUTH PLAINFIEL, NJ (US)

Correspondence Address: MICHAEL L DEVER, BUCHANAN INGERSOLL PROFESSIONAL CORP, ONE OXFORD CENTRE 20TH FLOOR, 301 GRANT STREET, PITTSBURGH, PA, 152191410

(21) Appl. No.: 08/523,405

(22) Filed: Sep. 5, 1995

Related U.S. Application Data
(63) Continuation-in-part of application No. 08/358,984, filed on Dec. 19, 1994, now abandoned.
Application No. 08/358,984 is a continuation of application No. 08/049,853, filed on Apr. 19, 1993, now abandoned.

(51) Int. Cl. B01D 53/48

(52) U.S. Cl. 423/230; 423/244.02

(57) ABSTRACT

A method for desulfurizing gases is provided in which microdomains or microcrystals, of cerium oxide are provided within an alumina substrate. The cerium oxide microdomains within the alumina react within the sulfur in the gases to reduce the sulfur content of the effluent gas. The use of microdomains provides a high surface area of cerium oxide, and a stable surface area of the cerium oxide, which react in a rapid fashion with the sulfur-containing molecules leading to effective desulfurization to levels produced by thermodynamic calculations of the effluent gas.

### FIELD OF THE INVENTION

This application is a continuation-in-part of application Ser. No. 08/358,984, filed Dec. 19, 1994, which was a continuation of application Ser. No. 08/049,853, filed Apr. 19, 1993. This invention relates to the use of cerium oxide in the form of microdomains, or microcrystals, from 1 nm to 150 nm diameter in size or microdomains or microcrystals in combination with high surface area bulk cerium oxide for the desulfurization of gases. Microdomains or their combination with high surface area bulk cerium oxide make possible: (1) desulfurization of gases to levels approaching those predicted by thermodynamic calculations, (2) desulfurization of gases at a higher rate, and, perhaps, (3) desulfurization of gases to a level lower than predicted by thermodynamic calculation when microdomains are utilized, and (4) higher utilization of the sorbent. [Utilization is the ratio of the amount of sulfur reacted with the sorbent to the stoichiometric amount of sulfur that is possible to react with the sorbent.] The cerium oxide microdomains of this invention have a stable surface area following repeated cycles of sulfur removal and regeneration at temperatures up to 1000° C.

### BACKGROUND OF THE INVENTION

Most of the electrical energy produced in the world is created by the combustion of sulfur-containing hydrocarbons. Most common of these sulfur-containing hydrocarbons are coal, oil, and natural gas. In this application the term “coal” will be used to describe all categories of these sulfur-containing hydrocarbons, but that term does not preclude the use of all forms of sulfur-containing hydrocarbons mentioned herein, or other sulfur containing hydrocarbons, which may be used in the practice of this invention.

Most of the electrical energy used today is created by the complete combustion of sulfur containing hydrocarbons in boilers. The gases created by this combustion contain sulfur dioxide (SO₂), water (H₂O), oxygen (O₂), nitrogen oxides [NO, N₂O, etc.] (known as NOₓ), and sulfur oxides [SO₂ and SO₃] (known as SOₓ). The generic name for such gases is “flue gases” and that term will be used hereinafter to describe such gases.

Future methods of production of electricity utilize processes such as Integrated Gasifier Combined Cycle (IGCC) systems or fuel cells or pressurized fluid bed combustion. In these methods of electric power production, the reaction of coal with oxygen is not carried to completion. As a result, the gases contain amounts of hydrogen (H₂) and carbon monoxide (CO) which are generally greater than the amount of carbon dioxide (CO₂) and H₂O in these gases. The sulfur from the coal used to produce these gases is mainly in the form of hydrogen sulfide (H₂S) or sulfur carbonyl (COS). Such gases are hereinafter referred to as “fuel” gases.

In the work on cerium oxide desulfurization of fuel gases conducted to date, the ratio of the sum of the reducing gases (H₂ and CO) divided by the sum of the oxidizing gases (CO₂ and H₂O) has been determined to be critical. The ratio (%CO+% H₂)/(%CO₂+%H₂O) has been used as a generic method of describing the reducing power of fuel gases. Hereinafter, that ratio will be called “Quality Factor”, and “QF” will be used hereinafter as an acronym for Quality Factor. The extent of desulfurization obtained experimentally during research on the use of CeO₂ for the desulfurization of various QF fuel gases produced by the incomplete combustion of hydrocarbons is shown in FIG. 1. FIG. 2 shows the extent of desulfurization of various QF gases at various temperatures as determined by thermodynamic calculations.

Desulfurization to the lowest possible levels of both fuel and flue gases is critical because of restrictions on the amount of sulfur released into the atmosphere from the combustion of coal. The restrictions have been imposed by the Clean Air Act, the provisions of which are enforced by the Environmental Protection Agency. Desulfurization to these low levels is also required for efficient, long term operation of IGCC systems and fuel cells. FIG. 3 shows that the ability of CeO₂ to desulfurize fuel gases, until the gases come to equilibrium with the CeO₂, is controlled by the surface area of the sorbent. The teachings of the present invention are directed to the production of microdomains of CeO₂ which have a very high surface area. This high surface area enables the CeO₂ to achieve and perhaps exceed the extent of desulfurization predicted by thermodynamic calculations.

In view of the possibility of a tax on carbon emissions from power plants or an energy tax on the combustion of hydrocarbons, it is important that these new processes be as efficient as possible. It has been determined that gasifiers which produce high QF gases are the most efficient. Cerium oxide can desulfurize high QF gases to lower levels than it can attain with low QF gases.

Desulfurization at the highest rate possible is also important. The rate of desulfurization will control the size of the equipment used in which desulfurization of fuel or flue gases is conducted. Smaller sized reaction vessels will reduce the capital cost for the desulfurization of gases.

It is also important that the utilization of the sorbent be as high as possible over many cycles of sulfidation and regeneration to minimize the amount of sorbent required.

The application of lanthanide oxides to substrates for desulfurization has been described previously. Kahn et al., U.S. Pat. No. 4,346,063, describes a method for using cerium oxide for desulfurization of gases containing H₂S by first oxidizing the H₂S to sulfur oxides. Kahn et al. does not suggest any method for the removal of H₂S from gases without first converting the H₂S to sulfur oxides.

The application of lanthanide oxides to substrates for desulfurization of fuel gases has been described by Wheelock et al., U.S. Pat. Nos. 3,974,256 and 4,002,270. However, Wheelock et al. fail to appreciate: (1) that cerium oxide was different from the other lanthanide oxides except praseodymium and terbium in that it crystallizes in the fluorite habit; (2) that, during regeneration of lanthanide sulfides or lanthanide oxy-sulfides other than cerium sulfide or cerium oxysulfide, lanthanide oxysulfate could be formed which would require temperatures in excess of 1500° C. to regenerate back to lanthanide oxide; (3) that in many cases the utilization of the sorbent for desulfurization would be reduced to a small fraction of its original utilization because of the formation of these lanthanide oxy-sulfates and lanthanide sulfates.

Furthermore, Wheelock et al. utilizes alkali or alkaline earth metal components (as oxides). Thus, the prior art, including Wheelock et al., failed to appreciate that the low melting point oxides of the alkalis would react with the lanthanide oxides and the Al₂O₃ substrate to create a mixture which may not be capable of reacting with the sulfur in either fuel or flue gases. Moreover, the prior art, including Wheelock et al., does not appreciate the importance of the use of cerium oxide microdomains, and combinations of cerium oxide microdomains and high surface area bulk cerium oxide, to increase the extent of desulfurization, the utilization of the sorbent, or the rate of desulfurization of sulfur-containing gases.

The application of cerium oxide coatings to substrates for the desulfurization of fuel gases has been suggested by Kay et al., U.S. Pat. No. 4,885,145. The information in Column 6, lines 3 through 7 of Kay et al. acknowledges that putting cerium oxide on a support would increase its utilization. Kay et al. states that increasing the utilization of the sorbent also increase the rate of desulfurization and the extent of desulfurization. However, Kay et al. does not appreciate the increased effectiveness of such coatings when the coatings contain microdomains of CeO₂. Moreover, Kay et al. also fails to recognize the methods necessary for the production of stable microdomains with high CeO₂ contents, i.e., greater than 50 weight % CeO₂ in the CeO₂/Al₂O₃ composite, by the use of alumina and ceria sols to prepare such composites. Nor does this patent recognize that specific methods of preparation using sol precursors of alumina and/or ceria result in more microdomains in the final sorbent than other more conventional preparation methods, such as impregnation of a soluble ceria precursor onto a porous Al₂O₃ support.

Longo, U.S. Pat. Nos. 4,001,375 and 4,251,496, describes the use of cerium oxide for the desulfurization of flue gases. The methods utilized by Longo to apply the cerium oxide to an Al₂O₃ support are described in detail in these patents. However, Longo does not teach or suggest the importance of maximizing the amount of the cerium oxide on the support in the form of microdomains and minimizing the amount of bulk cerium oxide formed. Moreover, Longo does not appreciate the importance of maximizing the number of microdomains in the cerium oxide-alumina sorbents to increase (1) the rate of reaction between the sulfur in flue gases and sorbents of this invention, (2) the utilization of the sorbent, and (3) the extent of desulfurization. Longo claims as an upper limit 40% CeO₂ content in the cerium oxide-alumina composite sorbent whereas use of sol precursors allows the preparation of CeO₂ contents up to 97% CeO₂ content, more preferably up to 80% CeO₂ content in the cerium oxide-alumina composite sorbent.

Kay et al., U.S. Pat. No. 4,885,145, describes the utilization of solid solutions of cerium oxide and other altervalent oxides of either other lanthanides or oxides of the alkaline earth elements to increase the utilization of the sorbents, which are solid solutions, as well as to increase the extent of desulfurization and the rate of desulfurization of fuel gases. However, Kay et al. does not recognize the use of cerium oxide microdomains in the sorbent nor the importance of maximizing the number of cerium oxide microdomains in the sorbent to increase the rate, extent of desulfurization, and utilization of the sorbent compared to the cerium-oxide-based solid solutions. Kay et al. further places a limitation on the amount of solute to be added to the cerium oxide solvent of 0.05 to 15 mole percent.

Koberstein et al., U.S. Pat. No. 5,024,985, describes a support material for a three-way automotive catalyst containing platinum group metal and having a reduced tendency for H₂S emissions. The support material is formed from an annealed spray-dried combination of aluminum oxide and cerium oxide. In the process described in Koberstein et al., SO₂ in the exhaust gas exiting the engine reacts under oxidizing conditions (λ=1.02) with the CeO₂ portion of the catalyst to form Ce₂(SO₄)₃. When a reducing gas (λ=0.92) is passed over the Ce₂(SO₄)₃, a release of H₂S and SO₂ occurs with the regeneration of Ce₂(SO₄)₃ back to CeO₂, which is again capable of reacting with the SO₂ in an oxidizing gas (λ=1.02). The reaction for the release of SO₂ and H₂S during regeneration of Ce₂(SO₄)₃ has been described in the Longo patents previously cited.

Koberstein et al. does not teach or suggest that the CeO₂ portion of the catalyst reacts with H₂S in the automobile exhaust gas. In fact, the exhaust gas exiting the automobile engine does not contain H₂S. Rather, the data of Koberstein et al. shows in the Examples provided therein that the smaller surface area of the CeO₂ portion of the catalyst annealed at 1000° C. limits the amount of SO₂ that reacts with the CeO₂ to form Ce₂(SO₄)₃, thereby limiting the amount of H₂S which may be subsequently emitted as a result of the chemically reducing action of the λ=0.92 gas with Ce₂(SO₄)₃.

Koberstein et al. illustrates this principle in Comparative Example 1 and Example 3. In Comparative Example 1, high surface area is maintained by a final annealing step in hydrogen at 550° C. for four hours. In Example 3, Koberstein et al. prepares the catalyst in the same manner as Comparative Example 1 except that the final annealing step is performed at 1000° C. for 24 hours in hydrogen. It is known to those skilled in the art that the surface area of CeO₂ is markedly reduced by annealing at temperatures as high as 1000° C. This is particularly true when the annealing step is performed in an atmosphere of hydrogen, which is necessary to reduce the hexachloroplatinic salt to platinum metal.

FIG. 4 shows the limited extent of desulfurization of flue gas with CeO₂ whose surface area is approximately 20 m²/gm. The extent of desulfurization in the second and third runs of this experiment illustrate a further decrease of the ability of the CeO₂ to react with SO₂ because of its smaller surface area due to the 950° C. regeneration temperature.

FIG. 5 herein depicts the results of experiments that show that bulk CeO₂ on an alumina support whose surface area was approximately 200 m²/gm has an initial capacity to completely eliminate SO₂ from simulated flue gas. However, when regenerated at 950° C., the surface area is diminished and the ability of the bulk CeO₂ to react with SO₂ is diminished further. This result is consistent with the results of Koberstein et al., discussed above.

FIG. 5 herein shows that a further decrease of the ability of the CeO₂ sorbent to react with SO₂ was attained after the second regeneration as shown in the third cycle of sulfidation where the sorbent was even less capable of reacting with SO₂. The time of regeneration was overnight, meaning at least 12 hours. These results demonstrate that exposure to high temperature decreases the surface area of CeO₂ sorbents resulting in the drastic decrease in their ability to react with SO₂. Based on experience with CeO₂ sorbents annealed in dry hydrogen for long times, the reduction of surface area of the catalyst in Example 3 of Koberstein et al. would have even greater reduction in surface area than the sorbents represented in FIG. 5 herein. Consequently, the catalyst of Example 3 of Koberstein et al. would have only a small fraction of the surface area of the catalyst of the Comparative Example 1. With the smaller surface area of the catalyst, less Ce₂(SO₄)₃ would be formed. As a consequence, less H₂S and SO₂ would be released when the Ce₂(SO₄)₃ is exposed to the chemically reducing (λ=0.92) exhaust gas.

Addiego, U.S. Pat. No. 5,212,130, describes another use for CeO₂ in automotive catalysts. In this case, the CeO₂ is used a rheological modifier or binder for a washcoat of other oxides to enhance the dispersion of the other active oxides in the catalyst. There is no suggestion in Addiego that the CeO₂ in these catalysts could react with either H₂S or SO₂.

Meng et al. suggests that cerium oxide can be put on a substrate. Meng et al. states that solid conversion of the low surface area (less than 1.0 m²/gm) or bulk CeO₂ to Ce₂O₂S in the order of 1% were obtained for the sorbent used in that study. Higher conversions should be attainable for cerium oxide sorbents prepared by impregnation of a very thin layer of a compound such as (NH₃)₂(Ce(NO₃)₆) on the outside of an inert support. However, the authors did not anticipate the superiority of microdomains of cerium oxide for the desulfurization of either fuel or flue gases where the cerium oxide-alumina composite sorbent contains levels of CeO₂ up to 97%.

Microdomains of CeO₂ within an Al₂O₃ support can be created for desulfurization of fuel and flue gases by the co-precipitation of CeO₂ and Al₂O₃ from colloidal oxide precursors. Microdomains can also be created on preformed Al₂O₃ substrates by utilizing procedures which insure the formation of microdomains on the substrate and minimize the formation of bulk cerium oxide by careful attention to the details of standard techniques. Increasing amounts of CeO₂ can be placed on substrates by utilizing the same procedures previously described for sequential impregnations to maximize the amount of CeO₂ present as microdomains, and to minimize the amount of bulk CeO₂.

Previous patents assigned either to Unocal or the Gas Desulfurization Corp (GDC) have described the use of bulk cerium oxide of low surface area of less than 5 m²/gm and bulk cerium oxide containing altervalent dopants of less than 5 m²/gm surface area to desulfurize gases resulting from the combustion of sulfur-containing hydrocarbons. When desulfurizing either fuel or flue gases resulting from the complete, or partial combustion, of sulfur-containing hydrocarbons, the extent of desulfurization possible with bulk cerium oxide can be estimated by thermodynamic calculations. When cerium oxide microdomains are used, they may enable the desulfurization of gases to levels equal to, or lower than, those predicted by thermodynamic calculations for bulk cerium oxide, by adsorption of sulfur on the surface of the CeO₂ microdomains.

It would be considered an improvement of the art if the use of microdomains, or combinations of microdomains and high surface area cerium oxide could increase the rate of desulfurization, increase the amount of sulfur removed from fuel and flue gases, and increase the utilization of the CeO₂ because of their larger surface area due to the small size of the microdomains. The surface area of cerium oxide microdomains, or combinations of microdomains and high surface area cerium oxide on substrates may be over 50 m²/gm and will have stable surface areas when subjected to high temperature conditions. The surface area of the bulk oxide used to date has been less than 2.5 m²/gm. Consequently, there is a need for a method to apply cerium oxide in the form of microdomains on a substrate to provide a surface area higher than 50 m²/gm.

In addition to achieving desulfurization of fuel gases to very low levels, this desulfurization must proceed at a very rapid rate with as nearly complete utilization of the CeO₂ as possible during repeated cycles of sulfidation and regeneration of the sorbent. Some methods of regeneration are conducted at temperatures greater than 900° C., and if the temperature at the start of regeneration is not as high as 900° C., the exothermic regeneration reaction may raise the sorbent temperature to 900° C. or higher. Therefore, it is important that the improvements in desulfurization attained with the use of CeO₂ microdomains be retained over multiple cycles of sulfidation and regeneration.

### SUMMARY OF THE INVENTION

In accordance with this invention, cerium oxide is present in the form of microdomains on a substrate, preferably alumina although titania, zirconia, silica, magnesia, or their combination with alumina may be used, or high surface area bulk cerium oxide, or combinations of microdomain cerium oxide and high surface area bulk cerium oxide, to increase the rate and extent of desulfurization of gases created by the combustion of sulfur-containing hydrocarbons, and increase the utilization of the sorbent. The cerium oxide microdomains of this invention have a stable surface area following repeated cycles of sulfur removal and regeneration at temperatures up to 1000° C.

Microdomains may be created in two ways. The first method is by co-precipitation from sols, or colloidal oxides, where the size of the alumina and cerium oxide sols used influences the size of the resulting cerium oxide microdomains. In the resulting product, the alumina acts as a host structure, the cerium oxide microdomains are mixed uniformly with the alumina particles which are present as a stable phase made of transitional alumina crystals capable of withstanding high temperature conditions. Microdomains of cerium oxide can also be produced when cerium-containing aqueous solutions such as cerium nitrate or cerium acetate are applied to inert oxide substrates such as alumina, silica, titania, zirconia and magnesia aluminate or their mixtures. In this case, the amount of the cerium oxide present as microdomains on the substrate and the size of the CeO₂ microdomains is controlled by the procedures used to coat the substrate.

### BRIEF DESCRIPTION OF THE DRAWINGS

FIG. 1 is a graph comparing the effect of the Quality Factor of a fuel gas with the H₂S concentration during secondary desulfurization.

FIG. 2 is a graph showing the effect of the Quality Factor of a fuel gas on the calculated H₂S equilibrium pressure.

FIG. 3 is a graph showing the experimental and extrapolated effect of surface area of the sorbent on the H₂S concentration during secondary desulfurization.

FIG. 4 is a graph showing the breakthrough curve of a CeO₂ sorbent.

FIG. 5 is a graph showing the breakthrough curve of CeO₂ on a high surface area alumina support.

FIG. 6 is a graph showing the utilization of the CeO₂ sorbent during desulfurization of fuel gases of various QF.

FIG. 7 is a graph showing the extent of desulfurization of the first and second cycles of QF 7.5 gas.

### DETAILED DESCRIPTION OF THE PREFERRED EMBODIMENTS

Many of the details of the formation of microdomains are in the public domain in Murrell et al., “Sols As Precursors to Transitional Aluminas and These Aluminas As Host Supports for CeO₂ and ZrO₂ Microdomains”. Murrell et al. describes the use of an approximately 20 nm alumina sol as the precursor to produce a transitional alumina that has a surface area of 142 m²/gm after calcination at 900° C. Alumina made from a 2 nm sol calcined at 900° C. has a surface area of only 114 m²/gm. Furthermore, the pore volume of the alumina prepared from the 20 nm alumina sols is three times greater than the pore volume obtained from the 2 nm sols.

When cerium oxide-alumina composites with 30 wt % cerium oxide in the composite are prepared with the 20 nm size alumina sol and cerium oxide sol, the resulting composite has a surface area of 150 m²/gm after calcination at 500° C. Furthermore, the pore volume of the CeO₂/Al₂O₃ composite is almost the same as the pore volume of the Al₂O₃ produced from the 20 nm alumina sol. The estimated domain size of the CeO₂ is approximately 12 nm. The equivalent surface area for these approximately 12 nm CeO₂ particles would be about 300 m²/gm based on CeO₂ on the composite. Little advantage was found in using 1 nm CeO₂ sols as the CeO₂ sol aggregates to form larger size CeO₂ microdomains.

The amount of CeO₂ that can be mixed with the alumina sols while maintaining a porous structure can be increased to 80% of the total, perhaps as high as 97%. The CeO₂ sols used in this process are almost completely converted to high temperature stable CeO₂ microdomains, whose size is entirely dependent on the amount of CeO₂ in the composite. The microdomains' size in the mixed CeO₂—Al₂O₃ composite is also dependant on the maximum temperature to which the composites are exposed, and duration of exposure at these high temperatures.

The details of the CeO₂ microdomains' size as a function of composition and temperature are discussed in Murrell et al. However, Murrell et al. does not appreciate the potential for the subject technology being extended to CeO₂ contents as high as 97% nor the use of cerium oxide-alumina composites manufactured with this technology for the desulfurization of gases.

Church et al., in “CATALYST FORMULATIONS 1960 TO PRESENT” presented in March 1989, describes the function of cerium oxide in automotive exhaust catalysts. It is important to note that there is no problem with sulfur emission in automotive exhaust. Removal of sulfur from gasoline is best conducted at the oil refinery where the gasoline is produced. The function of CeO₂ in these catalysts was described as one or more of the following: (a) to stabilize the surface area of the alumina washcoat, (b) to act as promoter for the platinum group metals, (c) to act as a storage component during rich and lean swings in the Air/Fuel ratio and (d) to promote the water gas shift reaction.

It may be that the major function of cerium is to act as a storage component during rich and lean swings in the Air/Fuel ratio. Only at an Air/Fuel (A/F) ratio of 14.6, which is the stoichiometric point of the A/F ratio, can the catalysts remove approximately 90% of the CO, hydrocarbons and NOₓ, from automotive exhaust gases. At any A/F ratio other than 14.6, reduction of either NOₓ, hydrocarbons or CO removal is less complete.

When CeO₂ is exposed to reducing gases it is quickly chemically reduced to a non-stoichiometric compound which is commonly called CeO(₂₋ₓ) which is between the composition of CeO₂ and Ce₂O₃ or CeO_{1.5}. The reduction of the CeO₂ to CeO(₂₋ₓ) consumes some of the reductants in the gases bringing the A/F ratio back to 14.6. As soon as the A/F ratio becomes oxidizing, the CeO(₂₋ₓ) is quickly converted back to CeO₂ where it again capable of reacting with a reducing A/F ratio. This ability of CeO₂ to react with reducing gases and oxygen permits the automotive catalyst to operate at this desirable A/F ratio of 14.6. Based on the function of CeO₂ in automotive catalysts, there was no reason for Murrell et al. to appreciate that CeO₂ could function to desulfurize gases.

Murrell et al. does not address the impact of impurities in either the Al₂O₃ or CeO₂ sols used to form the microdomains. Alumina is amphoteric in that in some instances it functions as an acid, whereas in other less frequent cases it functions as a base. Impurities, such as the oxides of potassium and sodium, in either the CeO₂ or Al₂O₃ sols that would be basic in nature would react preferentially with the alumina component. As a result of this reaction the surface area and the pore volume could be adversely impacted. In addition, impurities such as sodium and potassium oxides, may act as a flux which promotes the undesirable reaction of the CeO₂ and the Al₂O₃. The resulting composite from this reaction may have little or no capability to react with sulfur species in either fuel or flue gas. Therefore, it is important to minimize the impurities in the CeO₂ or Al₂O₃ sols used to prepare the composites of the instant invention.

Cerium oxide is a moderately strong base. When sorbents containing CeO₂ microdomains are heated to temperatures over 800° C. in dry hydrogen, a reaction can occur wherein the CeO₂ microdomains react with the Al₂O₃, forming cerium-aluminate (CeAlO₃) . As a result, the CeO₂ that reacts with the Al₂O₃ is no longer capable of reacting with the sulfur of either flue or fuel gases. Under applications with water vapor present there should not be an issue of the CeO₂ microdomains reacting with the Al₂O₃ which functions as a support or host for the CeO₂. For example, microdomains in CeO₂—Al₂O₃ composites are stable at least up to 1000° C., probably to 1100° C., when exposed to gases which have at least 2.5% H₂O in them. As the temperature is increased, the surface area of the CeO₂—Al₂O₃ composite is decreased. As an example, a sorbent prepared from 30% CeO₂-70% alumina sols has a surface area of 150 m²/gm after calcination at 500° C. However, if, as reported by Murrell et al., the calcination temperature of such a sorbent is increased to 900° C., the surface area decreases to 103 m²/gm.

Another advantage of the sol precursors used to prepare the sorbents with microdomains of the instant invention is the ease of processing the compositions containing cerium oxide-alumina, cerium oxide-zirconia-alumina, cerium oxide-titania-alumina, cerium oxide-silica-alumina, or combinations thereof, into attrition resistant aggregates or particles. The composite oxides of the instant invention can be aggregated into very attrition resistant particles by spray drying, or mixing the composite gel formed from the precipitated sols during the final stages of the drying step of the composite. Alternatively, the mixed sols can be added directly to a spray dryer or to a fluid bed unit to form the attrition resistant particles of desired size as is well known to those skilled in the art. The mixed sols may also be formed into attrition resistant particles by passing an atomized spray of the mixed sols through a reactor at a temperature greater than 300° C.

Another method to control the mixed sol gelation process to produce microdomains of CeO₂ is to rapidly heat the liquid containing the sols with microwave radiation, for example with a temperature rise as high as 25° C. per second. Other methods to rapidly increase the temperature while mixing the sol slurry mixture at an optimum stirring rate to produce aggregates in the solution with a narrow-size distribution and with good attrition resistance is possible using conventional heating methods. These procedures prevent the formation of nitrogen oxide (NOₓ) emissions often encountered following ammonium hydroxide gelling procedures when the gelled materials are calcined to convert the gel to the final oxide structure.

The use of sols of cerium oxide and alumina, described above, will produce the greatest number of CeO₂ microdomains. However, microdomains of CeO₂ in combination with high surface area bulk CeO₂ can be produced by close control of conventional techniques for the application of CeO₂ to stable substrates such as alumina. The source of the CeO₂ for these techniques is a liquid soluble compound of cerium that when heated dissociates into CeO₂. There are at least four such cerium oxide containing compounds:

1. Cerium nitrate (Ce(NO₃)₂·6H₂O);

2. Cerium acetate (Ce(C₂H₂O₂)₃);

3. Cerium oxalate (Ce₂(C₂O₃)·9H₂O); and

4. Ammonium cerium nitrate [(NH₃)₂(Ce(NO₃)₆)]

All of these cerium compounds listed dissociate when heated and the compound resulting from the heating is CeO₂. These liquid soluble compounds that form CeO₂ are called CeO₂ “precursors”, and this is a term commonly used by the formulators of catalysts for liquid soluble compounds of other elements that when heated result in the formation of oxide of the element. The term “precursors” will be used frequently in the descriptions of other methods of achieving microdomains of CeO₂ on stable oxide substrates.

By careful control of the liquid volume containing the soluble cerium oxide precursor added to a preformed porous support, microdomains of cerium oxide can be created on the support surface following drying and calcination in air at a temperature sufficient to decompose the precursor salt. For example, on a preformed alumina substrate, cerium oxide can be deposited by standard impregnation procedures using a soluble precursor such as Ce(NO₃)₃.

There are a number of methods for utilizing aqueous solutions of cerium salts for impregnating alumina substrates. Repeated impregnation steps will increase the amount of cerium oxide formed within the pore structure of the alumina. The major objective of the process of the invention is to insure that the coating of cerium salt is applied uniformly to the substrate so that when the cerium salt is dried and calcined the maximum number of microdomains of CeO₂ are formed uniformly throughout the alumina substrate. Some cerium oxide may be reacted with the alumina surface forming a surface interactive phase, but beyond this level cerium oxide will form predominantly microdomains within the pore voids of the alumina support.

The preferred technique for achieving this goal of maximizing the amount of microdomains on a substrate is to impregnate the water soluble cerium salts by the incipient wetness technique. In the case where the substrate has a significant portion of the pore volume in pores greater than 20 nm in diameter, CeO₂ particles will likely be formed in such a large size as to approach the characteristics of bulk CeO₂. For substrates of this invention, it is useful to have a balance of pores with a diameter of 20 nm with those of larger size so that the greatest number of CeO₂ microdomains of small size (1 to 15 nm in diameter) be formed within the substrate. This avoids the requirement of going through an aqueous gelation step. By control of the rate of flow through the controlled temperature zone of the reactor, and by control of the temperature profile in the reactor zone, the attrition resistance of the particles of the mixed oxide composite and their size can be modified in a systematic way as is well known to those skilled in the art.

The substrates which can be used to support the cerium oxide microdomains include at least one of the group consisting of alumina, silica, silica-alumina, titania, zirconia, clays, zeolites, and diatomaceous earths. The surface area of the substrate, preferably alumina, should be less than 250 m²/gm, more preferably similar to that of the substrate after prolonged use at high temperature.

An example of the use of the incipient wetness technique is as follows:

1. Use ten grams of the substrate dried at 110° C. and impregnate the substrate with water with thorough mixing in order to determine the weight of uptake of water before the sample transform to a paste-like state. The pore volume of substrates will usually be in the range of 0.3 to 1.5 cc./gm as determined by the addition of water to the substrate.

2. Prepare a saturated solution of Ce(NO₃)₃·6(H₂O)

3. Add the solution prepared in step (2) to 10 gm of substrate so that the volume of liquid added is the same as the pore volume determined in step (1)

4. Dry at 120° C. for two hours

5. Calcine at 500° C./600° C. for two hours

6. The addition of subsequent amounts of the solution prepared in step (2) to the sample prepared in step (5) will introduce increasing amounts of CeO₂ on the substrate

This technique adds just a sufficient amount of cerium nitrate to provide a uniform coating on the substrate. When this uniform coating of cerium nitrate is dried and calcined the resulting cerium oxide will be uniformly distributed over the surface of the substrate. This uniform coating will maximize the formation of microdomains and minimize the formation of bulk cerium oxide. Repeating this procedure through subsequent preparations introduces an increasing concentration of CeO₂ on the substrate in the form of microdomains which are of high surface area which is the basis of this application.

Using the procedure described above, it is possible to put on as much as 17 weight % CeO₂ on an alumina substrate of about 0.5 cc/gm pore volume in a single impregnation step. If the substrate and CeO₂ were calcined at 800° C. to 900° C., there might be as much as 5 to 10 weight % of the CeO₂ that could react with the alumina substrate. The CeO₂ which reacts with the alumina substrate is not functional as a sorbent for sulfur in either fuel or flue gases. However, the CeO₂ on the alumina substrate beyond that which has reacted with the substrate will form CeO₂ microdomains which are capable of reacting with the sulfur in either fuel of flue gases. In order to maximize the active microdomains it is advantageous to use multiple impregnation steps so that a high concentration of active microdomains will be formed on the substrate.

It is possible to prepare CeO₂ on a substrate as described in the preceding paragraph. Such substrates will have and maintain the desired combination of attrition resistance along with high surface area. The amount of CeO₂ in the first coating could be doubled by a subsequent coating, but little or none of the CeO₂ in the second coat would react with the substrate.

Improvements in this technique are possible. First, it would be helpful if the amount of CeO₂ reacting with the alumina substrate could be reduced. Second, it would be helpful if the surface area of the substrate was stabilized to minimize the reduction in the surface area that can occur when these sorbents are exposed for long times at high temperature. It is likely that a reduction in surface area of the alumina substrate would be beneficial in preventing formation of a cerium oxide-alumina composite phase, such as a surface oxide phase of cerium oxide reacted with the acidic alumina surface, which would have no sulfur sorption capacity. However, the decreased surface area of the alumina would favor the formation of larger CeO₂ microdomains compared to an alumina substrate which maintained a higher surface area. An alumina substrate with too low a surface area may even result in the formation of bulk CeO₂ within the alumina substrate.

In order to increase the amount of CeO₂ in the form of small and intermediate size crystals, 1-30 nm diameter in size on the alumina substrate, it is advantageous to either precoat the alumina substrate with a more basic oxide than CeO₂, or simultaneously introduce the more basic oxide along with the CeO₂. The basic oxides which can improve the stability of the alumina substrate, and simultaneously increase the amount of small microdomains of CeO₂ present, include at least one of the following basic oxides of magnesium, lanthanum, strontium, and barium. It is probably most useful to simultaneously introduce the soluble precursors of the basic oxide with the soluble CeO₂ precursor as it is anticipated that the more basic oxide will preferentially interact with the alumina surface thereby allowing the CeO₂ to form small microdomains.

If a soluble magnesium oxide precursor is impregnated on an alumina substrate by the incipient wetness technique, or by other techniques know to those skilled in the art, prior to application of the CeO₂ as a soluble precursor salt, the basic MgO could react with the lewis acid sites of the alumina after calcination between 300° C. and 900° C. In that event, some of the magnesium oxide may react with the alumina to form a support which is stable at high temperatures. Such an amorphous magnesium-alumina composite, or spinel, or mixed phases could both stabilize the alumina phase of the composite so that it can be utilized at extreme high temperatures. Also such a composite, or spinel, or mixed phases could be expected to be a useful support to stabilize the CeO₂ introduced to such a composite, and also would be expected to prevent the undesirable interaction of CeO₂ with the alumina surface. It may be possible to form the desired microdomains structure of CeO₂ on a magnesia-alumina composite by introducing the soluble magnesia and cerium salts in a single step or sequential impregnation steps. It may also be desirable to form magnesia-alumina deposits by contacting the alumina with a magnesia nitrate, or other salt which has been heated above the melting point of the salt. This procedure of using the molten salts of magnesium allows very high levels of magnesia oxide precursor to be introduced into the alumina substrate where subsequent drying and calcination results in a high conversion of the alumina to the desired basic magnesia-alumina composite, or spinel, or mixed phases.

Addition of at least one of the basic oxides of magnesium, lanthanum, strontium, and barium to the cerium oxide-alumina composites of this invention could also be beneficial as stabilizers of the alumina surface area in cerium oxide-alumina composites made from sol precursors. The basic oxide, or combination of basic oxides, acting as a stabilizer of the alumina surface at extreme high temperature conditions maintains the cerium oxide domains in as small a size as is possible. This is important because of the extreme temperatures for some of the sorbent applications of this invention. The basic oxide precursor or precursors may be added subsequent to the gelation of the cerium oxide substrate composites of this invention, or by addition to the slurry during gelation, or added to the cerium oxide and/or to the alumina sol, or other oxide sols, during the preparation of the cerium oxide substrate composites.

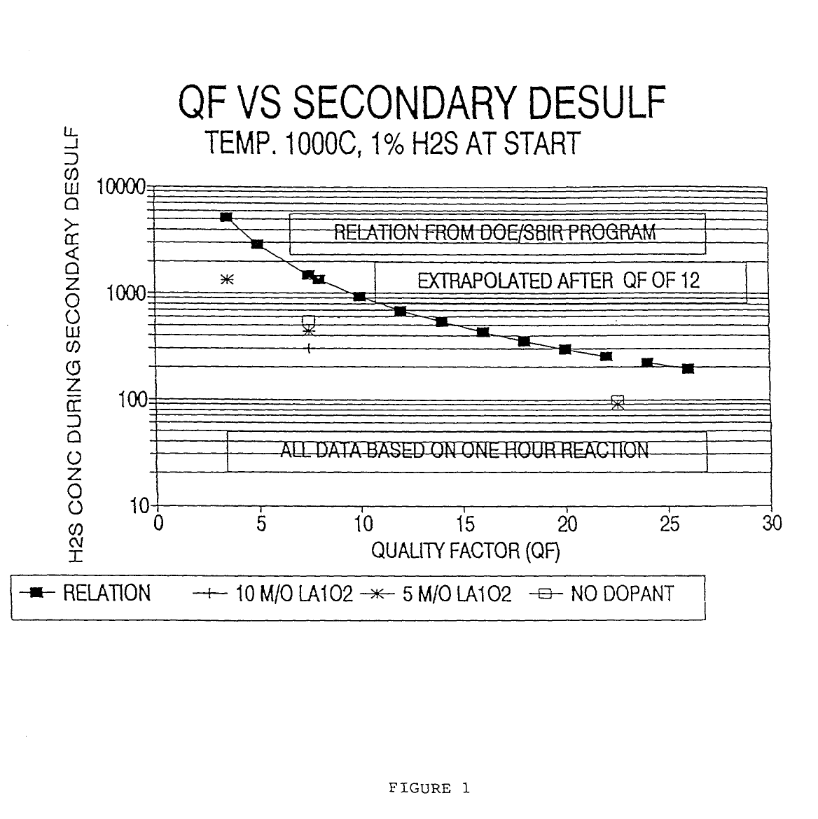

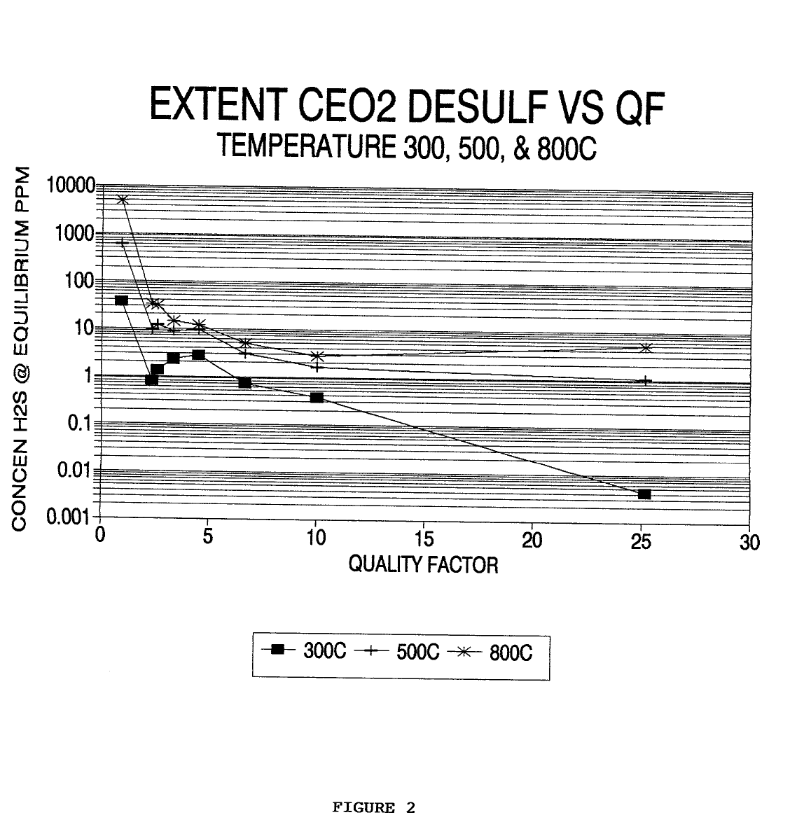

The results of desulfurization of various QF fuel gases with doped and undoped CeO₂ at 1000° C. are shown in FIG. 1. The results shown here include those obtained during a Department of Energy/Small Business Innovation Research (DOE/SBIR) grant and a Department of Energy/Energy Related Inventions Program (DOE/ERIP) program. The extent of desulfurization of various QF fuel gases predicted by thermodynamic calculations are shown in FIG. 2. Comparison of the experimental results with the predicted levels of desulfurization shows the lanthanum oxide-doped cerium oxide solid solutions are unable to achieve the extent of desulfurization predicted by thermodynamic calculations. The comparison does show the lanthanum oxide-doped cerium oxide does achieve greater sulfur removal from these fuel gases than undoped CeO₂.

Comparison of the results obtained during the DOE/SBIR and DOE/ERIP programs show a significant difference in the extent of desulfurization. For illustration, the results obtained during the DOE/SBIR program with QF 7.5 gases shows desulfurization to approximately 1500 ppm H₂S. In contrast desulfurization of QF 7.5 gas with undoped CeO₂ to a level of 550 ppm H₂S was obtained during the DOE/ERIP program. Both CeO₂ sorbents used in the DOE/SBIR and the DOE/ERIP program were made from the same raw materials. The only significant difference was in their surface area. The sorbent made during the DOE/SBIR program had a surface area of 1.1 m²/gm and the sorbent made during the DOE/ERIP had a surface area of 2.4 m²/gm. By inspection it can be seen that the increase in extent of desulfurization due to an increase in surface area is greater than the increase in extent of desulfurization due to doping.

It is also important to note that the extent of desulfurization predicted from the thermodynamic data for QF 7.5 gas at 800° C. is 5 ppm H₂S whereas the lowest H₂S content obtained experimentally is only 300 ppm at 1000° C. Thus, the microdomains of CeO₂ of the instant invention should provide a further improvement over the low surface area samples investigated to date.

### EXAMPLE I

In the work performed under the DOE/SBIR and DOE/ERIP funding, desulfurization of fuel gases has been to two levels. The lowest level or “primary desulfurization” was related to the composition of the cerium oxide because it had been exposed to H₂ prior to its exposure to the H₂S-containing gases. more rigorous examination of the data indicated that these low levels of desulfurization were closely related to the equilibrium concentrations of H₂S associated to the QF of the gases being desulfurized. Duration of “primary desulfurization” has varied from 10 to 50 minutes with the longer times associated with the number of oxygen ion vacancies available. The less complete desulfurization or “secondary desulfurization” was determined by a stabilized condition controlled by the rate of diffusion of the sulfur from the surface of the sulfided CeO₂ to its center.

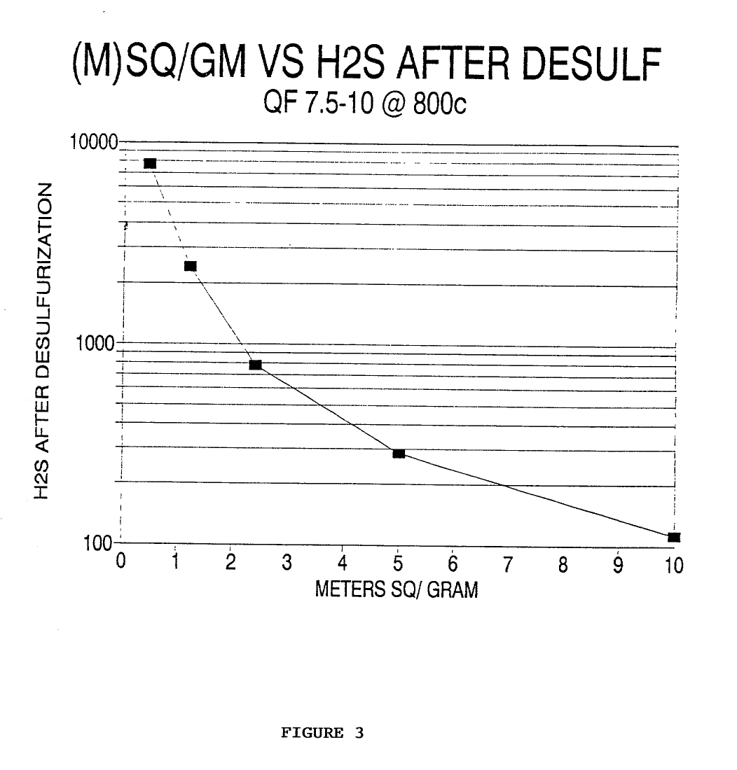

In order for cerium oxide to be a commercial and technical success, desulfurization must be to levels equal to or better than those predicted by thermodynamic calculations. Data is available from Meng, the DOE/SBIR program, and the DOE/ERIP program which illustrates more clearly the effect of surface area on the extent of desulfurization during secondary desulfurization. The graph of this data is shown in FIG. 3. The data from which this relationship is established includes CeO₂ with surface areas of 0.45 to 2.4 m²/gm.

Because of the very high coefficient of determination of the relationship for the available data, it was deemed possible to extrapolate the relationship to higher values of surface area. The extrapolated relation indicates that a surface area of less than 10 m²/gm would be required to attain H₂S levels of 100 ppm in fuel gases of this composition. This is not appreciably higher than the 41 ppm H₂S predicted by thermodynamic calculations for QF 2.5 gases.

If the cerium oxide is in the form of microdomains whose effective surface area could be as high as 100 m²/gm, equilibrium could be achieved at very high rates of desulfurization. Cerium oxide added to substrates by the incipient wetness impregnation technique contains microdomains whose size is approximately 2 nm, with some CeO₂ present as an unreactive CeO₂-alumina product and/or with CeO₂ present as a bulk oxide phase. The cerium oxide component of the sorbent prepared from sols or by incipient wetness techniques may have an effective surface area from 50 to 100 m²/gm. Such a high surface area cerium oxide particle would be capable of reaching equilibrium with any gas whose QF exceeds 2.0. However, the rate of reaction of the sorbent made from the sols containing microdomains should be greater than those created by incipient wetness techniques. Also, the capacity of sulfur sorption would be greater due to the higher effective CeO₂ surface provided by higher CeO₂ content in the CeO₂—Al₂O₃ composite for the sol-derived composites compared to those obtained by adding soluble cerium oxide precursors to a preformed support.

A major function of doping CeO₂ and the use of sol-derived composites is to increase the rate of reaction, extent of desulfurization, and utilization of the sorbent between the cerium oxide and the H₂S in the fuel gas. As a result, the H₂S content of the fuel gases in contact with cerium oxide will be lower. In the case of increasing the rate by doping CeO₂, it has been impossible, with one exception, to achieve desulfurization to the low levels predicted by thermodynamic calculations with low surface area cerium oxide sorbents. The implication of the data in FIG. 3 is that the surface area of the cerium oxide in the form of microdomains would be sufficient to achieve desulfurization to the limits predicted by equilibrium calculations.

### EXAMPLE II

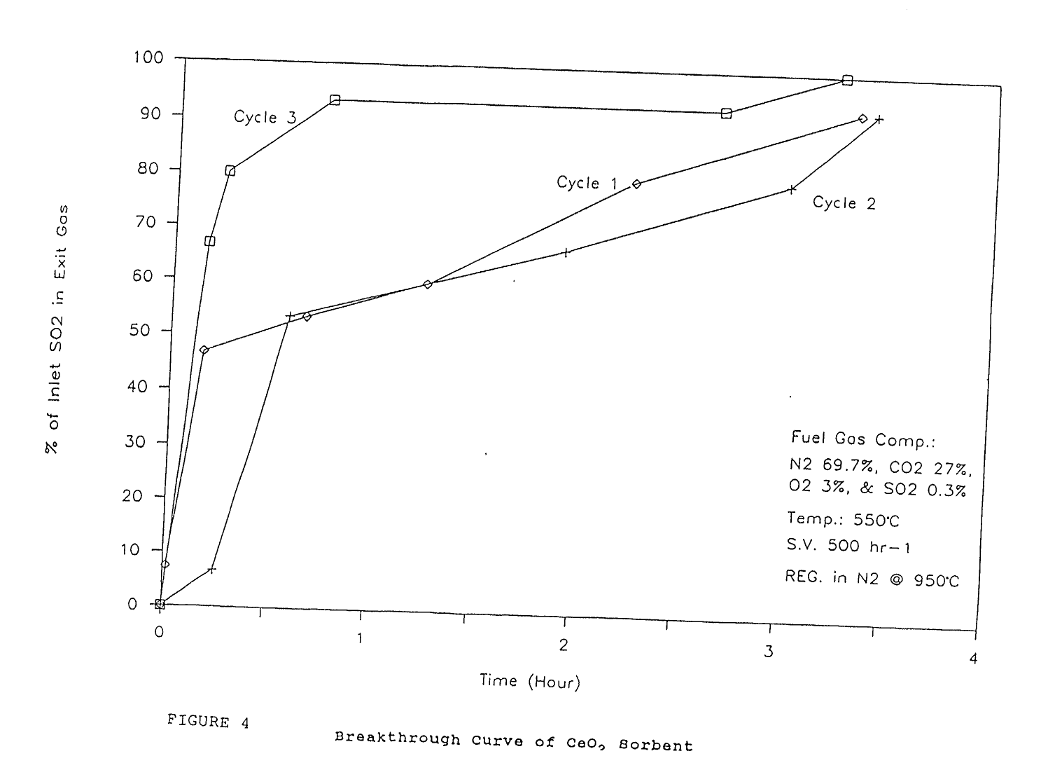

Work conducted by Electrochem Inc. of Woburn, MA and GDC illustrates the influence of surface area of the cerium oxide on its ability to desulfurize flue gases. In this work flue gases representative of those resulting from the combustion of coal were passed over cerium oxide. In one case the cerium oxide was not on a support, and the surface area of the cerium oxide was approximately 20 m²/gm. The composition of the flue gas was 69.7% N₂, 27% CO₂, 3.0% O₂, and 0.3% SO₂. The desulfurization was conducted at 550° C. Space velocity of the flue gas was 500 hr⁻¹. Regeneration of the sulfated cerium oxide was conducted at 950° C. With this cerium oxide with low surface area there was little reduction of SO₂ in the first run and less in succeeding runs after regeneration in air at 950° C. as shown in FIG. 4. Previous work by GDC had shown that raising the temperature of the cerium oxide sorbent used in this experiment to 950° C. decreased its volume which in turn would be expected to decrease its surface area.

Since the result of desulfurization of the flue gas with 20 m²/gm was unsatisfactory, the cerium oxide was placed on an alumina substrate whose surface area was 240-250 m²/gm. The procedure used was to soak the alumina pellets in cerium nitrate, dry the pellets after being removed from the cerium nitrate solution at 100° C., and finally calcining the cerium-nitrate-coated pellets (which have been previously dried) at 600° C. in air. There was no attempt to maximize the number of microdomains on the substrate with this procedure. The pellets produced in this fashion were exposed to flue gases of the same composition as that given in the proceeding paragraph. The temperature of desulfurization was raised to 600° C. and the space velocity was increased to 1000 volumes/volume/per hour.

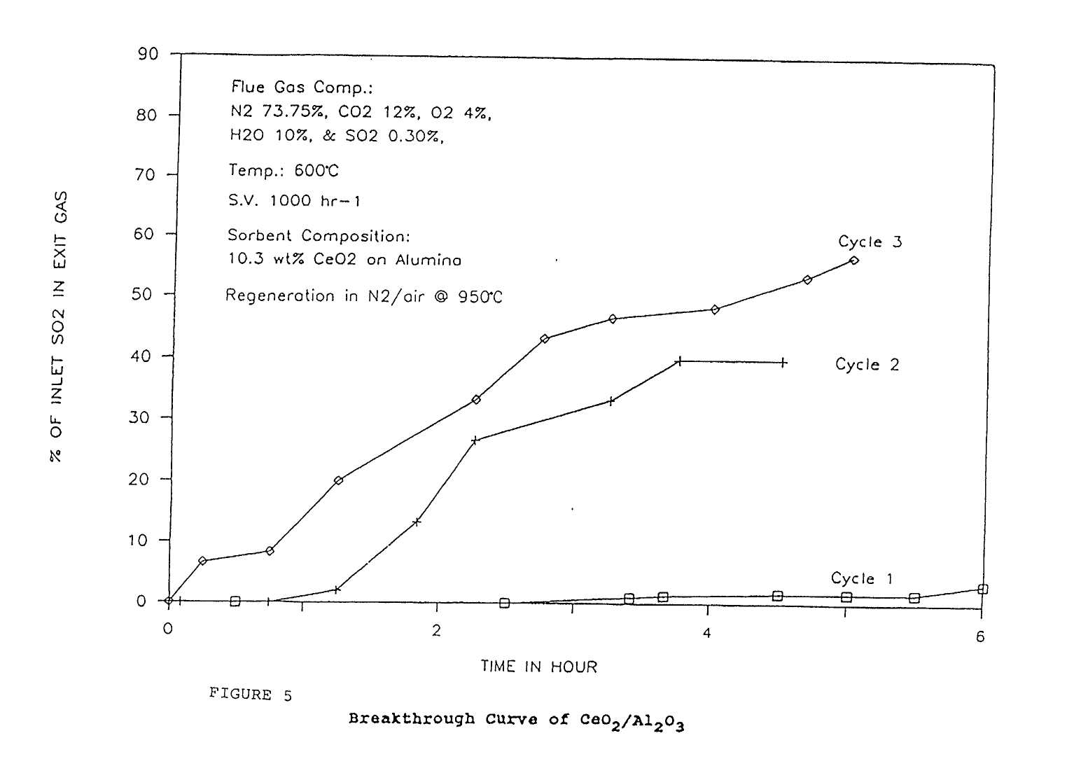

The data presented in FIG. 5 shows a dramatic improvement in the ability of cerium oxide on this alumina substrate to desulfurize flue gas. However, regeneration at 950° C. either caused a drastic reduction in surface area of the substrate, or agglomeration of the cerium oxide into large bulk CeO₂ particles or formation of CeAlO₃. As a result there was much less desulfurization of the flue gases in succeeding runs.

The results of this work illustrate: (1) the effect of increasing surface area of the cerium oxide to increase the extent of desulfurization of flue gases, and (2) the importance of creating microdomains of cerium oxide on stable substrates to be able to repeatedly desulfurize flue gases to low concentrations of sulfur dioxide.

Experience has shown that in other systems in which microdomains are used it has been possible for reactions to progress beyond the limits predicted by thermodynamic calculations. The explanation for reactions exceeding the limits predicted by thermodynamic calculations is that because of the large surface area of the microdomains the bonds between ions of the cerium oxide are not as great as those in bulk cerium oxide. As a result, the reactions can proceed further and faster. In addition it is possible to have sulfur occluded to the microdomains surface.

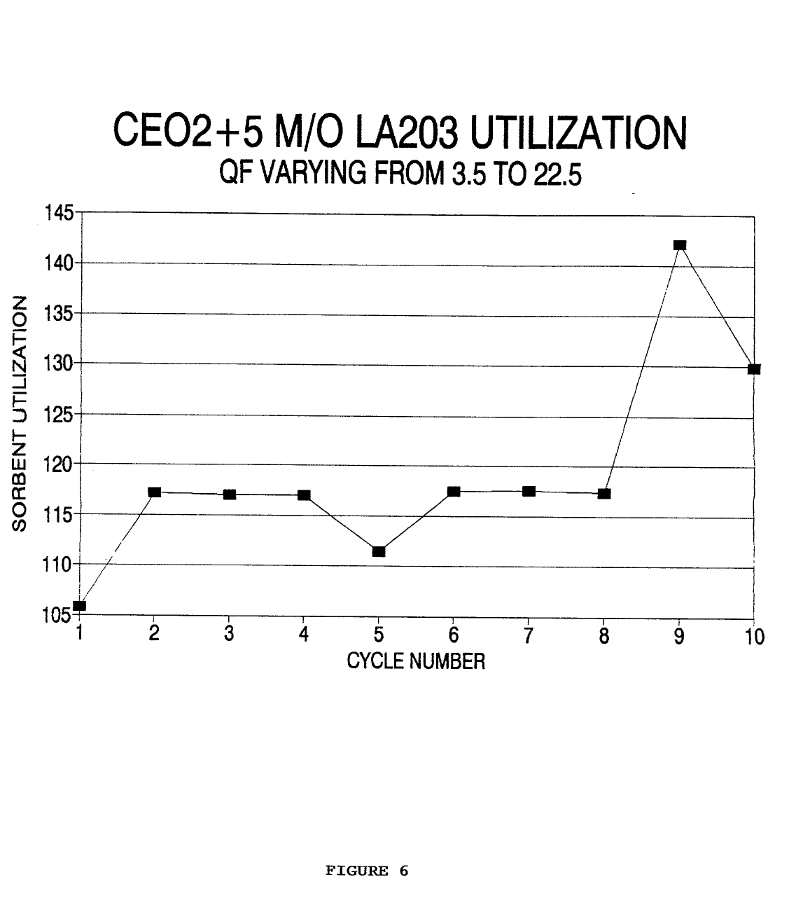

Work performed during the DOE/ERIP program showed that utilization of the sorbent with repeated cycles of desulfurization and regeneration increased with successive cycles. This data is shown in FIG. 6.

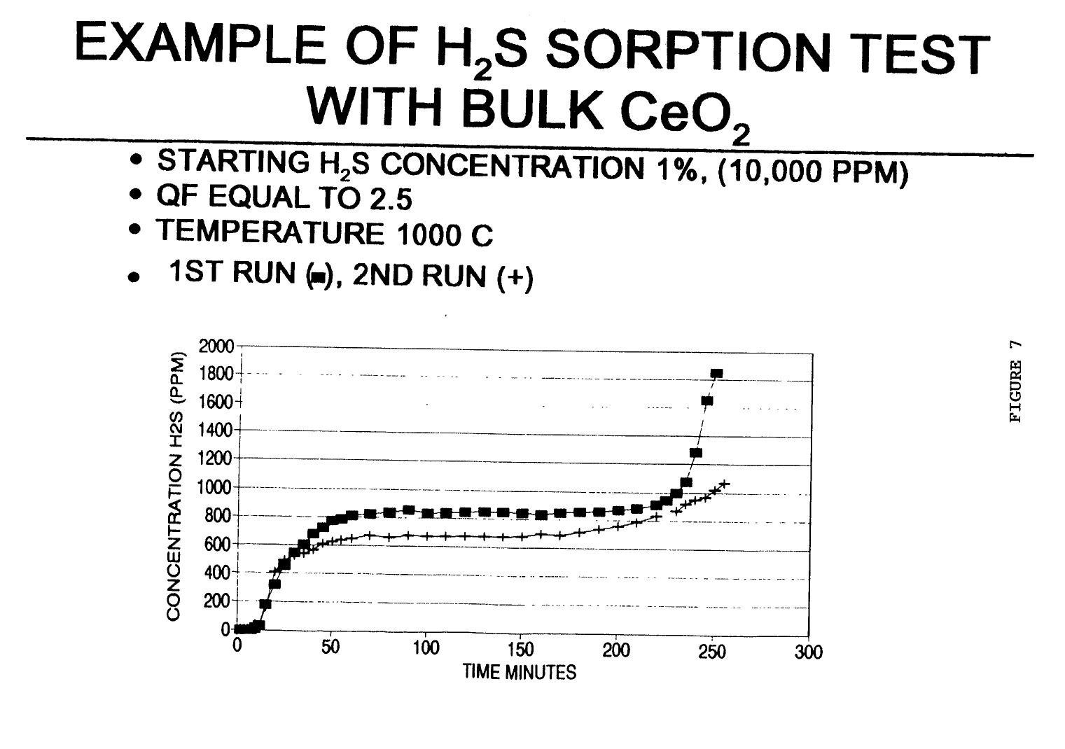

It is known there is a difference in the crystal dimensions of cerium oxide and Ce₂O₂S formed by desulfurization of fuel gas. These changes in crystal dimensions can create stresses in the bulk cerium than can cause the crystals to fracture increasing the surface area of the cerium oxide. More sulfur ions could thereby be occluded to the CeO₂ of increased surface area, and/or by greater rate of reaction with the larger surface of the fractured CeO₂ particles. In many cases during the DOE/ERIP program the extent of desulfurization during the first cycle of desulfurization and regeneration was lower than was obtained in the second cycle. FIG. 7 shows this improvement in desulfurization between the first and second cycles.

Various embodiments and modifications of this invention have been described in the foregoing description and examples, and further modifications will be apparent to those skilled the art. Such modifications are included within the scope of the invention as defined by the following claims:

We claim:

1. A method for the desulfurization of gases created by combustion of sulfur containing hydrocarbons comprising the steps of providing microdomains of cerium oxide on a substrate and exposing the microdomains of cerium oxide to said gases, wherein said cerium oxide microdomains react with the sulfur in said gases to reduce the sulfur content of the effluent gas.

2. The method of claim 1 wherein the gases to be desulfurized are created by the complete combustion of sulfur containing hydrocarbons and the sulfur is in the form of sulfur dioxide.

3. The method of claim 1 wherein the gases to be desulfurized are created by the incomplete combustion of sulfur containing hydrocarbons and the sulfur is in the form of hydrogen sulfide.

4. The method of claim 1 further comprising the step of forming the cerium oxide microdomains by the use of sols of alumina and cerium oxide to produce mixed CeO₂—Al₂O₃ composites to form the composite oxide.

5. The method of claim 4 further comprising the step of increasing the surface area of the resulting microdomains of cerium oxide by the use of a 20 nanometer size alumina sol to form the composite oxide.

6. The method of claim 4 wherein the composition of the sols of alumina and cerium oxide is 97 weight % cerium oxide and 3 weight % alumina.

7. The method of claim 6 wherein the composition of the sols of alumina and cerium oxide is 80 weight % cerium oxide and 20 weight % alumina.

8. The method of claim 7 wherein the composition of the sols of alumina and cerium oxide is 70 weight % cerium oxide and 30 weight % alumina.

9. The method of claim 1 further comprising the step of forming the microdomains of cerium oxide by impregnating cerium oxide precursors onto a substrate selected from the group consisting of alumina, silica-alumina, zirconia, titania, clay, zeolite and diatomaceous earth.

10. The method of claim 9 wherein the cerium oxide and microdomains are created by impregnating cerium oxide onto alumina substrates in an amount required for an incipient wetness method.

11. The method of claim 9 wherein the cerium oxide microdomains are created by multiple impregnation steps with at least one of intermediate drying and calcination steps between impregnations.

12. The method of claim 11 wherein precursors of a solvent of cerium oxide and a solute of at least one oxide altervalent to cerium oxide are combined to form a cerium oxide solid solution, said solid solution being in the form of microdomains to further increase the rate of reaction with the sulfur-containing gases created by combustion of sulfur-containing hydrocarbons.

13. The method of claim 9 further comprising the steps of removing sulfur from the cerium oxide microdomains at a selected temperature and regenerating the cerium oxide at a selected temperature, wherein the substrate is alumina, wherein the surface area of said alumina substrate has been made stable at the sulfur removal and cerium oxide regeneration temperatures by calcining at a temperature equal to the sulfur removing or regeneration temperatures which ever is higher.

14. The method of claim 13 wherein precursors of a solvent of cerium oxide and a solute of at least one precursor of an oxide altervalent to cerium oxide are combined to form a cerium oxide solid solution, said solid solution being in the form of microdomains to further increase the rate of reaction with the sulfur-containing gases created by combustion of sulfur-containing hydrocarbons.

15. The method of claim 1 wherein said substrate is alumina further comprising the step of creating the cerium oxide microdomains by coating the alumina substrate with a precursor of a basic oxide known to stabilize the surface area of alumina prior to coating the substrate with a cerium oxide precursor to reduce the reaction between the deposited cerium oxide microdomains and the substrate during high temperature use.

16. The method of claim 1 further comprising the steps of coating an alumina substrate with a precursor of a basic oxide and a stabilizing oxide precursor and placing at least one of the oxides of the alkaline earth elements consisting of the group comprising La₂O₃, MgO, BaO, SrO, and CaO on the substrate prior to or simultaneously with the coating of the substrate, wherein soluble precursors of said oxides are employed, said soluble precursors being at least one of a nitrate, sulfate, oxalate, and acetate.

17. The method of claim 1 further comprising the step of regenerating the sulfided cerium oxide microdomains, wherein the ability of the cerium oxide microdomains to desulfurize gases is maintained for a plurality of cycles of sulfidation and regeneration by increasing the ability of the support on which the microdomains are deposited to retain its original surface area by utilizing a multi-component system in which one of the components may be chosen from a soluble precursor of at least one of the oxides of silicon, zirconium, titanium, and cerium oxide.

18. The method of claim 17 further comprising the step of introducing a second component of the multi-component system into the manufacture of the multi-component system by way of sols of the oxides.

19. The method of claim 18 further comprising the step of increasing the attrition resistance of the cerium oxide microdomain-containing multi-component system by the use of sol precursors added during the final drying step of the sorbent preparation of at least one of the sols of the oxides of silicon, titanium, and zirconium.

20. The method of claim 18 further comprising the step of increasing the attrition resistance of the cerium oxide microdomain-containing multi-component system by adding mixed sols directly to one of a spray dryer and a fluid bed unit to form attrition resistant particles of uniform size.

21. The method of claim 18 further comprising the step of increasing the attrition resistance of the cerium oxide microdomain-containing multi-component system by passing an atomized spray of the mixed sols through a reactor zone at a temperature of at least 200° C. to convert the sols to their mixed oxide precursor composites without the requirement of going through an aqueous gelation step.

22. The method of claim 18 further comprising the step of increasing the attrition resistance of the cerium oxide microdomain-containing multi-component system by control of the rates of flow through a relatively high temperature zone having a temperature ranging from 300° C. to 1000° C., wherein the temperature profile in the high temperature zone controls the size and attrition resistance of the composite particles of the mixed oxides.

23. The method of claim 18 further comprising the step of increasing the attrition resistance of the cerium oxide microdomain-containing multicomponent system by rapidly increasing the temperature at a rate of at least 2° C./minute while mixing the solution so as to produce aggregates in solution of uniform size distribution.

24. A method for the creation of the cerium oxide microdomain for the desulfurization of gases resulting from the combustion of sulfur-containing hydrocarbons wherein solid solutions of cerium oxide microdomains are formed, said solid solutions including at least one of the altervalent oxides of members of the lanthanide group of elements and altervalent oxides of the alkaline earth elements to further increase the number of oxygen ion vacancies whereby the rate of reaction with the sulfur-containing gases created by combustion of sulfur-containing hydrocarbons is increased, and desulfurization of the sorbent is enhanced.
